(19) United States
(12) Patent Application Publication
(10) Pub. No.: US 2023/0289760 A1
(43) Pub. Date: Sep. 14, 2023

(54) OPERATION MANAGEMENT SYSTEM AND OPERATION MANAGEMENT PROGRAM

(71) Applicant: Prime Planet Energy & Solutions, Inc., Tokyo (JP)

(72) Inventors: Katsushi SAITO, Nagakute-shi (JP); Hideyuki NAGAI, Nagoya-shi (JP); Masaru ANDO, Seto-shi (JP); Masanori IECHIKA, Toyota-shi (JP)

(21) Appl. No.: 18/160,313

(22) Filed: Jan. 27, 2023

(30) Foreign Application Priority Data
Jan. 31, 2022 (JP) 2022-013228

(51) Int. Cl. G06Q 20/14; B60L 53/66

(52) U.S. Cl. CPC G06Q 20/14; B60L 53/665

(57) ABSTRACT

The herein disclosed operation management system includes an on-vehicle terminal, a disposed-at-facility terminal, a passenger terminal, and a management terminal. The on-vehicle terminal calculates a first electric power in which a fare to be paid by a passenger is converted into an electric power. The disposed-at-facility terminal calculates a second electric power in which a discounting process has been performed on the first electric power in response to a customer coming process performed by the passenger. The passenger terminal performs a process for supplying the second electric power to the commercial facility. The management terminal transfers an operation fee containing a fare to the operating company from the commercial facility. The system can generate a constant advantage for each of the passenger, the operating company, and the commercial facility.

### CROSS REFERENCETO RELATED APPLICATIONS

The present application claims the priority based on Japanese Patent Application No.2022-13228 filed on Jan. 31, 2022, and the entire contents of it are incorporated in the present specification by reference.

### BACKGROUND

### 1. Technical Field

The present disclosure relates to an operation management system and an operation management program. For more details, it relates to an operation management system that is configured to perform management related to a fare of an electric vehicle, and relates to an operation management program for making a computer operate the operation management system.

### 2. Description of the Related Art

Recently, private power generating equipments, such as solar power generating apparatuses, are getting to be spread to general households. Then, according to this spread of the private power generating equipments, an electric power selling process is also widely performed in which a surplus electric power of a household is supplied to others (for example, electric power company) so as to obtain a countervalue (incentive). Furthermore, a system is also proposed in which a passenger directly performs an electric power selling operation to a facility (factory, commercial facility, or the like) of a company other than the electric power company. For example, JP2015-5205 proposes a system in which a passenger having used an electric vehicle (EV bus, or the like) performs electric power selling to an operating company, instead of paying a fare. In particular, an operation management system described in JP2015-5205 calculates an electric power consumption for one person from an electric power consumption of an electric vehicle in an operation section and from a passage person (boarding person). Then, in this operation management system, the passenger registers a sold electric power amount, and a fare to be actually paid by the passenger is calculated from the sold electric power amount and the electric power consumption for one person.

### SUMMARY

According to the operation management system described in JP2015-5205, it is possible to provide the passenger of the electric vehicle with a merit of using the transportation service with surplus electric power of the house. However, this operation management system has a problem that a merit for the operating company providing the transportation service is smaller. For example, the operating company possessing the electric vehicle often possesses a private power generating equipment, too. In that case, if the operating company receives the electric power instead of the fare, it merely induces increasing its own surplus electric power. Then, in order to provide a pecuniary profit to the operating company, it is required to sell the surplus electric power to a third party (electric power company, or the like). In other words, in view of the operating company, the conventional operation management system needs more works to obtain the pecuniary profit, and introducing the conventional operation management system generates merely a smaller merit.

The present disclosure has been made in order to solve the problem as described above, and has an object of providing an operation management system that generates a constant advantage for each of the system users.

In order to solve the above described problem, an operation management system including the following configurations is provided.

The herein disclosed operation management system includes an on-vehicle terminal, a disposed-at-facility terminal, an electric power supply processing unit, and a fee transferring unit. The on-vehicle terminal is mounted on an electric vehicle possessed by an operating company, and is configured to calculate a first electric power in which a fare to be paid by a passenger is converted into an electric power. The disposed-at-facility terminal is disposed at a commercial facility, and is configured to calculate a second electric power in which a discounting process is performed on a first electric power in response to a customer coming process performed by a passenger. The electric power supply processing unit is configured to perform a process in which the passenger supplies the second electric power to a commercial facility. The fee transferring unit is configured to transfer an operation fee containing a fare from a commercial facility to an operating company.

Regarding the herein disclosed operation management system, in response to the customer coming process performed by the passenger on the disposed-at-facility terminal at the commercial facility, the discounting process is performed on the electric power to be supplied, instead of the fare. In other words, the present system can provide the passenger of the electric vehicle with not only a merit of using the transportation service with the surplus electric power of the own house, but also a merit of substantially discounting the fare. Next, the herein disclosed operation management system transfers the operation fee (various prices containing the fare) to the operating company from the commercial facility at which the passenger has performed the customer coming process. In other words, the present system can provide the operating company with the merit of obtaining the pecuniary profit, more easily than the conventional system. Then, the herein disclosed operation management system supplies the electric power (second electric power), on which the discounting process has been performed, from the passenger to the commercial facility. In general, the commercial facility consumes huge amount of electric power, and thus a merit of receiving the surplus electric power of the passenger for the commercial facility is larger than one for the operating company. In addition, if the passenger uses the present system, it is required to perform the customer coming process with the disposed-at-facility terminal which is disposed in the commercial facility. Thus, according to the present system, it is possible to provide the most important merit for the commercial facility, while the merit is to increase the number of coming customers. As described above, according to the herein disclosed operation management system, it is possible to generate a constant advantage for each of the system users.

In a suitable aspect of the herein disclosed operation management system, the on-vehicle terminal includes a boarding certification issuing unit. The boarding certification issuing unit is configured to issue a boarding certification which is boarding information containing a first electric power. At the customer coming process, a passenger makes a disposed-at-facility terminal read a boarding certification. By doing this, the customer coming process for the commercial facility can be performed easily and accurately.

In a suitable aspect of the herein disclosed operation management system, an image display apparatus and an advertisement displaying unit are mounted on an electric vehicle. The advertisement displaying unit is configured to display an advertisement of a commercial facility on the image display apparatus. A fee transferring unit is configured to add a countervalue of an advertisement to an operation fee and transfer to an operating company. According to the present aspect, not only the merit of increasing the number of coming customers can be provided to the commercial facility, but also a merit of increasing the pecuniary profit can be provided to the operating company.

In a suitable aspect of the herein disclosed operation management system, an advertisement transmitting unit is mounted on an electric vehicle. The advertisement transmitting unit is configured to transmit an advertisement of a commercial facility to a portable terminal possessed by a passenger. A fee transferring unit is configured to add a countervalue of an advertisement to an operation fee so as to transfer to an operating company. Even when the present aspect is applied, not only the merit of increasing the number of coming customers can be provided to the commercial facility, but also a merit of increasing the pecuniary profit can be provided to the operating company.

In a suitable aspect of the herein disclosed operation management system, a fee transf erring unit is configured to add a customer coming reward, corresponding to a customer comin g process, to an operation fee so as to transfer to an operating company. By doing this, it is po ssible to provide the operating company with a merit of increasing the pecuniary profit.

In a suitable aspect of the herein disclosed operation management system, a disposed-at-facility terminal is configured to subtract a second electric power based on a payment amount of a passenger at a commercial facility. According to the present aspect, the merit of subtracting the second electric power can be provided to the passenger, and further the merit of accelerating the passenger’s consumption activity can be provided to the commercial facility.

Additionally, in the aspect of subtracting the second electric power based on the payment amount of the passenger, it is preferable that a fee transferring unit is configured to add a part of a payment amount of a passenger at a commercial facility to an operation fee so as to transfer to an operating company. By doing this, it is possible to provide the operating company with a merit of increasing the pecuniary profit.

In addition, as another aspect of the herein disclosed technique, an operation management program is provided. The operation management program as described above is configured to make a computer perform a step for calculating a first electric power in which a fare, to be paid by a passenger with respect to use of an electric vehicle possessed by an operating company, is converted into an electric power, a step for calculating a second electric power in which a discounting process is performed on a first electric power when a customer coming process for recording that a passenger has come to a commercial facility is performed, a step for supplying a second electric power by a passenger to a commercial facility, and a step for transferring an operation fee containing a fare to an operating company from a commercial facility. According to the operation management program as described above, it is possible to easily construct the operation management system including the above described configurations.

### BRIEF DESCRIPTION OF THE DRAWINGS

FIG. 1 is a conceptual view that shows an operation management system in accordance with one embodiment.

FIG. 2 is a block diagram that shows a configuration of each terminal used in the operation management system in accordance with one embodiment.

FIG. 3 is a flowchart that shows an overview of processing steps on the operation management system in accordance with one embodiment.

FIG. 4 is a flowchart that shows an example of a processing procedure of “use of electric vehicle S100” in FIG. 3.

FIG. 5 is a flowchart that shows a processing procedure of “use of commercial facility S200” in FIG. 3.

FIG. 6 is a flowchart that shows a processing procedure of “supply of second electric power S300” in FIG. 3.

FIG. 7 is a flowchart that shows a processing procedure of “transfer of operation fee S400” in FIG. 3.

### DETAILED DESCRIPTION

### Embodiment 1

Below, one embodiment of a herein disclosed technique will be explained, while referring to figures. Incidentally, the matters other than matters particularly mentioned in this specification, and required for practicing the present disclosure (for example, configuration of each equipment constructing a system, or the like) can be grasped as design matters of those skilled in the art based on the related art in the present field. The herein disclosed technique can be executed based on the contents disclosed in the present specification, and the technical common sense in the present field. Incidentally, in the figures referred by the following explanation, the members/parts providing the same effect are provided with the same numerals and signs.

### 1. Configuration of Operation Management System

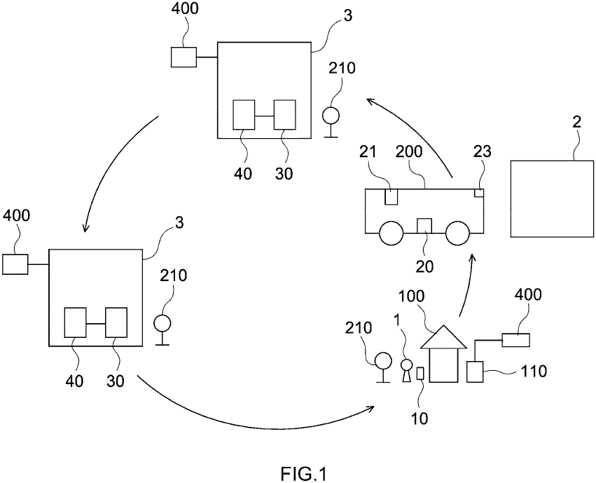

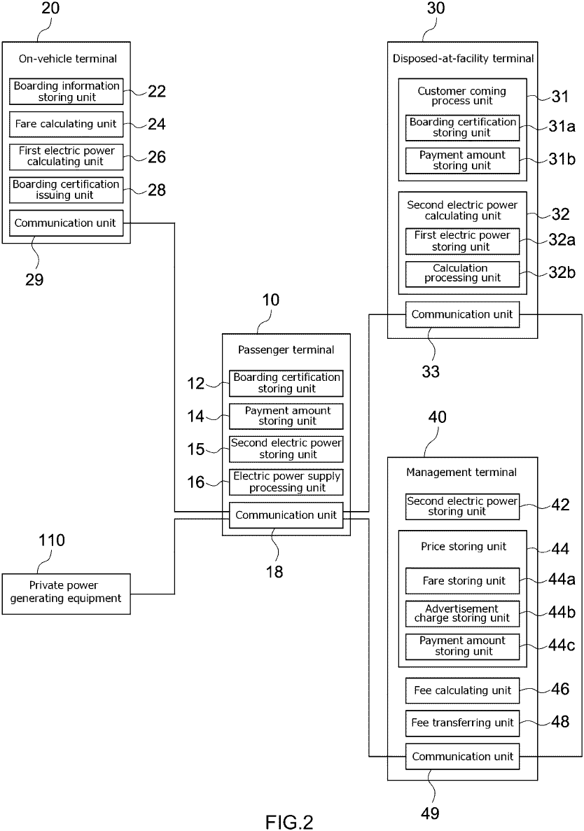

FIG. 1 is a conceptual view that shows an operation management system in accordance with the present embodiment. In addition, FIG. 2 is a block diagram that shows a configuration of each terminal used in the operation management system. As shown in FIG. 1, the operation management system in accordance with the present embodiment is a system used by a passenger 1, an operating company 2, and commercial facilities 3. Below, each of them will be described.

### Passenger

As shown in FIG. 1, a private power generating equipment 110 is disposed at a residence 100 of the passenger 1. The private power generating equipment 110 as described above is electrically connected to an external system 400. Then, the private power generating equipment 110 is configured to be capable of supplying surplus electric power (electric power selling operation) to others via the external system 400. Incidentally, the private power generating equipment 110 is not to restrict the herein disclosed technique, and thus a conventionally known power generating equipment can be used without particular restriction. For example, the private power generating equipment 110 includes an electric power generating apparatus, such as solar power generating apparatus, gas electric power generating apparatus, and wind force electric power generating apparatus. In addition, it is preferable that the private power generating equipment 110 includes an electric power storage apparatus connected to the electric power generating apparatus described above. By doing this, the electric power generated by the electric power generating apparatus can be accumulated in the electric power storage apparatus, and thus it is possible to efficiently secure the surplus electric power for the electric power selling operation. Incidentally, as for the electric power storage apparatus, it is possible to use a secondary battery or the like, such as lithium ion secondary battery.

In addition, the passenger 1 possesses a passenger terminal 10. As shown in FIG. 2, the passenger terminal 10 in the present embodiment includes a boarding certification storing unit 12 that is configured to store a boarding certification, a payment amount storing unit 14 that is configured to store a payment amount P, a second electric power storing unit 15 that is configured to store a second electric power E₂, an electric power supply processing unit 16 that is configured to instruct the private power generating equipment 110 to perform electric power supplying (electric power selling) to others, and a communication unit 18 that is configured to communicate with an outside equipment. Incidentally, detailed contents of processing for each unit will be described later. In addition, a communication method of “communication unit” in the present specification might be a wire communication or might be a wireless communication, which is not particularly restricted. In addition, the passenger terminal 10 might include an image display means (display, or the like) that is configured to display various information. As one example of a particular configuration of this passenger terminal 10, it is possible to use a portable terminal, such as smartphone, tablet terminal, and mobile computer. However, a configuration of the passenger terminal 10 can be suitably changed as needed, which is not to restrict the herein disclosed technique.

### Operating Company

The operating company 2 is to use an electric vehicle 200 possessed by itself so as to provide a transportation service to the passenger 1. As one example of the electric vehicle 200 described above, it is possible to use an EV bus or an EV taxi. Below, a case where the electric vehicle 200 is the EV bus will be described. As shown in FIG. 1, when the electric vehicle 200 is the EV bus, there are plural vehicle-stops 210 on a travel route of this electric vehicle 200. Each of the vehicle-stops 210 is disposed near the residence 100 of the passenger 1 or the commercial facility 3. The electric vehicle 200 stops at each of the vehicle-stop 210 so as to allow the passenger 1 to get on/off. By doing this, it is possible to transport the passenger 1 to a desired place. At that time, a duty is caused on the passenger 1 to pay a fare F, which is a countervalue for use of the electric vehicle 200, to the operating company 2.

In addition, an on-vehicle terminal 20 is mounted on the electric vehicle 200. As shown in FIG. 2, this on-vehicle terminal 20 includes a boarding information storing unit 22 that is configured to store boarding information for the passenger 1, a fare calculating unit 24 that is configured to calculate the fare F for which the passenger 1 has to pay, a first electric power calculating unit 26 that is configured to calculate a first electric power E₁ in which the fare F is converted into an electric power, a boarding certification issuing unit 28 that is configured to issue a boarding certification to the passenger 1, and a communication unit 29 that is configured to perform communication with the outside equipment. Incidentally, detailed contents of the processing for each unit will be described later. In addition, even a configuration of the on-vehicle terminal 20 can be suitably changed as needed, which is not to restrict the herein disclosed technique. For example, the on-vehicle terminal 20 might be a computer disposed in the electric vehicle 200, or might be a portable terminal (smartphone, tablet terminal, mobile computer, or the like) having been lent to a crew member (driver, or the like) of the electric vehicle 200.

Additionally, in the electric vehicle 200 of the present embodiment, an image display apparatus (not shown in figures) and an advertisement display unit 21 are mounted. The advertisement display unit 21 is configured to make the image display apparatus display an advertisement of the commercial facility 3. Additionally, in this electric vehicle 200, an advertisement transmitting unit 23 is also mounted. The advertisement transmitting unit 23 is an equipment for transmitting the advertisement of the commercial facility 3 to the passenger terminal 10. By doing this, the passenger 1 can see the advertisement of the commercial facility 3 with the own passenger terminal 10. By mounting these advertisement display means in the electric vehicle 200, it is possible to induce a customer to come to the commercial facility 3. In addition, although more details are described later, the operation management system in accordance with the present embodiment is configured to pay a countervalue (advertisement charge A) from the commercial facility 3 to the operating company 2, while the countervalue is for the display of the advertisement as described above.

### Commercial Facility

The term “commercial facility” in the present specification is a concept widely and semantically covering a facility that provides goods or services so as to obtain countervalues. In other words, the herein disclosed technique is not restricted by a type of goods (or services) provided at the commercial facility nor by a business type of the commercial facility. In addition, the commercial facility is not restricted to a private facility nor a public facility. As one example for this commercial facility, it is possible to use a shopping center, a shopping arcade, an amusement park, an accommodation, a restaurant, a tourist facility, a tutoring school, a culture school, a hospital, a post office, an amusement facility (movie theater, public bathhouse, or the like), or the like.

As shown in FIG. 1, the operation management system in accordance with the present embodiment includes a disposed-at-facility terminal 30 that is disposed at the commercial facility 3. This disposed-at-facility terminal 30 includes a customer coming process unit 31 in which a customer coming process by the passenger 1 is performed, a second electric power calculating unit 32 that is configured to calculate a second electric power E₂ based on the customer coming process of the passenger 1, and a communication unit 33 that is configured to perform communication with the outside equipment (see, FIG. 2). Further particularly, the customer coming process unit 31 includes a boarding certification storing unit 31a that is configured to store a boarding certification, and a payment amount storing unit 31b that is configured to store a payment amount P of the passenger 1 for the commercial facility 3. In addition, the second electric power calculating unit 32 includes a first electric power storing unit 32a that is configured to store a first electric power E₁, and a calculation processing unit 32b that is configured to calculate a second electric power E₂ from the first electric power E₁. Incidentally, detailed contents of process on each unit will be described later. In addition, the disposed-at-facility terminal 30 might include an image display means (display, or the like) that is configured to display various information. Incidentally, the configuration of the disposed-at-facility terminal 30 can be suitably changed as needed, which is not to restrict the herein disclosed technique. For example, the disposed-at-facility terminal 30 might be a computer fixed at a specific position in a store of the commercial facility 3, or might be a portable terminal (smartphone, tablet terminal, mobile computer, or the like) lent to a store assistant of the commercial facility 3.

### Management Terminal 40

In addition, the commercial facility 3 in the present embodiment possesses a management terminal 40, too (see FIG. 1). As shown in FIG. 2, the management terminal 40 includes a second electric power storing unit 42 that is configured to store the second electric power E₂ having been calculated by the disposed-at-facility terminal 30, a fee transferring unit 48 that is configured to transfer an operation fee C to the operating company 2, and a communication unit 49 that is configured to perform communication with the outside equipment. In addition, the management terminal 40 in the present embodiment includes a price storing unit 44 that is configured to store various prices used for calculating the operation fee C, and a fee calculating unit 46 that is configured to calculate the operation fee C based on the various prices. In particular, the price storing unit 44 includes a fare storing unit 44a that is configured to store a fare F which is to be paid by the passenger 1 to the operating company 2, an advertisement charge storing unit 44b that is configured to store a countervalue (advertisement charge A) for the advertisement displayed in the electric vehicle 200, and a payment amount storing unit 44c that is configured to store a payment amount P of the passenger 1 for the commercial facility 3. Incidentally, a detail of each unit will be described later. In addition, the configuration of the management terminal 40 is not to restrict the herein disclosed technique. The management terminal 40 might be a computer disposed in a store of the commercial facility 3.

Incidentally, each of the above described units is implemented with a hardware of each terminal and a program stored in the hardware. In other words, according to the herein disclosed technique, an electric power management program for implementing the system control apparatus (computer) including the above described configuration is also provided.

### 2. Processing Step of Operation Management System

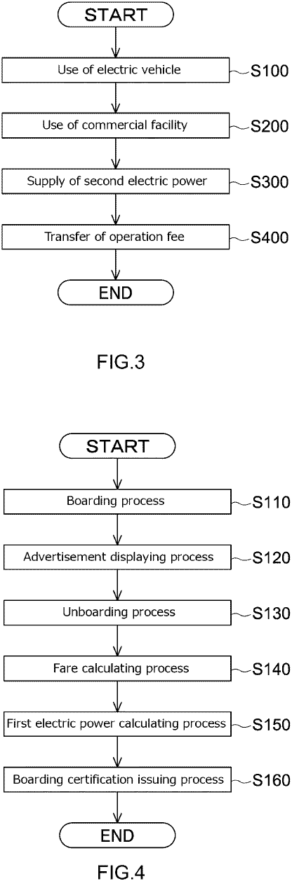

Next, processing steps of the operation management system in accordance with the present embodiment will be described. FIG. 3 is a flowchart that shows an overview of processing steps of the operation management system in accordance with the present embodiment. As shown in FIG. 3, the processing steps in the present embodiment include a use of electric vehicle S100, a use of commercial facility S200, a supply of second electric power S300, and a transfer of operation fee S400. Below, each step will be described.

### Use of Electric Vehicle S100

The term “use of electric vehicle S100” in FIG. 3 means a processing step performed when the passenger 1 uses the electric vehicle 200. FIG. 4 is a flowchart that shows an example of a processing procedure at “use of electric vehicle S100” in FIG. 3. As shown in FIG. 4, at the use of electric vehicle S100 on the present embodiment, a boarding process S110, an advertisement displaying process S120, an unboarding process S130, a fare calculating process S140, a first electric power calculating process S150, and a boarding certification issuing process S160 are performed.

### 1) Boarding Process S110

At the present step, information that the passenger 1 boarded on the electric vehicle 200 is stored in the on-vehicle terminal 20. In particular, the passenger 1 makes the passenger terminal 10 and the on-vehicle terminal 20 communicate with each other when having boarded on the electric vehicle 200. By doing this, boarding information of the passenger 1 is stored in the boarding information storing unit 22. Incidentally, the boarding information contains information for specifying the passenger 1 (name, or the like), and information for boarding position (name of vehicle-stop 210, or the like), boarding date, or the like.

### 2) Advertisement Displaying Process S120

Next, at the present step, the electric vehicle 200 displays an advertisement of the commercial facility 3 to the passenger 1 on board. For example, the advertisement display unit 21 of the electric vehicle 200 displays the advertisement of the commercial facility 3, positioning on a travel route, on the image display apparatus in the vehicle. On the other hand, the advertisement transmitting unit 23 transmits the advertisement of the commercial facility 3 to the passenger terminal 10. At that time, the passenger 1 can make the image display means of the passenger terminal 10 display the advertisement received by the advertisement transmitting unit 23. In addition, the passenger terminal 10 might be configured to select and display an advertisement corresponding to a taste of the passenger 1 among the advertisements having been transmitted from the advertisement transmitting unit 23. By displaying these advertisements in the vehicle, it is possible to provide the commercial facility 3 with a merit of increasing a number of customers coming to the store. Incidentally, the advertisement displayed, while the passenger 1 is boarding, is recorded in the boarding information storing unit 22.

### 3) Unboarding Process S130

Then, when the electric vehicle 200 reached at a destination, the passenger 1 performs the unboarding process S130. Particularly, at the present step, the passenger 1 makes the passenger terminal 10 and the on-vehicle terminal 20 communicate with each other, again. By doing this, unboarding information of the passenger 1 is stored in the boarding information storing unit 22. This unboarding information contains information about unboarding position (name of the vehicle-stop 210, or the like), unboarding day and time, or the like.

### 4) Fare Calculating Process S140

Next, the on-vehicle terminal 20 performs the fare calculating process S140 for calculating the fare F at a timing when the passenger 1 performed the unboarding process. For example, the fare F is calculated on the basis of the boarding position and unboarding position of the passenger 1. In particular, the fare calculating unit 24 calculates an operation distance based on the boarding position and unboarding position recorded in the boarding information storing unit 22. Then, the fare calculating unit 24 is storing a fare table in which a correspondence relation between the operation distance and the fare F is set. The fare calculating unit 24 is configured to calculate the fare F that the passenger 1 should pay, by referring to this fare table. Then, the fare F having been calculated is transmitted to the first electric power calculating unit 26 and the boarding certification issuing unit 28.

### 5) First Electric Power Calculating Process S150

At the present step, the first electric power calculating unit 26 converts the fare F, to be paid by the passenger 1, into the first electric power E₁. For example, the first electric power calculating unit 26 is storing an electric power conversion table in which the correspondence relation between the fare F (money) and the first electric power E₁ (kWh) is set. The first electric power calculating unit 26 calculates the first electric power E₁ corresponding to the fare F, by referring to this electric power conversion table. Then, the first electric power E₁ having been calculated is transmitted to the boarding certification issuing unit 28.

### 6) Boarding Certification Issuing Process S160

Next, the on-vehicle terminal 20 performs the boarding certification issuing process S160 for issuing a boarding certification for a passenger 1 having performed the unboarding process. For example, the boarding certification issuing unit 28 transmits the boarding certification to the passenger terminal 10 via the communication unit 29. Then, this boarding certification is stored in the boarding certification storing unit 12 of the passenger terminal 10. Incidentally, “boarding certification” in the present specification is a term widely representing various boarding information generated in response to the passenger’s use of electric vehicle. The boarding certification of the herein disclosed technique contains at least the first electric power E₁. In other words, the boarding certification is not particularly restricted if containing the first electric power E₁, and thus information other than the first electric power E₁ can be suitably added. For example, the boarding certification in the present embodiment contains “fare F to be paid by the passenger”, “content of advertisement having been displayed on board”, and “use time of electric vehicle”, in addition to the above described “first electric power E₁”.

### Use of Commercial Facility S200

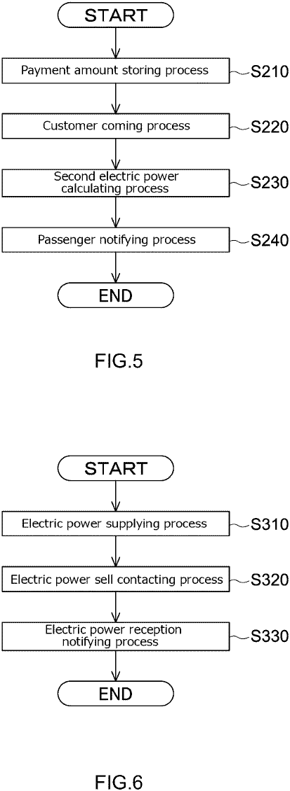

In FIG. 3, “use of commercial facility S200” is a processing step when the passenger 1 having unboarded from the electric vehicle 200 uses the commercial facility 3. FIG. 5 is a flowchart that shows a processing procedure of “use of commercial facility S200” in FIG. 3. As shown in FIG. 5, at the use of commercial facility S200 in the present embodiment, a payment amount storing process S210, a customer coming process S220, a second electric power calculating process S230, and a passenger notifying process S240 are performed.

### 1) Payment Amount Storing Process S210

First, when having received a service (goods selling, service providing, or the like) at the commercial facility 3, the passenger 1 pays the countervalue for the service to the commercial facility 3. Then, a price of paid countervalue (payment amount P) is stored in the payment amount storing unit 14 of the passenger terminal 10. Incidentally, when the passenger 1 does not receive a service for which the countervalue is required, this step is omitted.

### 2) Customer Coming Process S220

Next, the passenger 1 performs the customer coming process S220, in which the fact that the passenger has come is recorded, with the disposed-at-facility terminal 30 being disposed at the commercial facility 3. For example, at the present step, the passenger 1 makes the passenger terminal 10 and the disposed-at-facility terminal 30 communicate with each other. At that time, the passenger terminal 10 transmits the boarding certification, having been stored in the boarding certification storing unit 12, to the disposed-at-facility terminal 30. Then, the disposed-at-facility terminal 30 stores the received boarding certification in the boarding certification storing unit 31a. As described above, the boarding certification contains the boarding information of the passenger 1 (fare F, first electric power E₁, boarding time, or the like). Thus, by transmitting this boarding certification to the disposed-at-facility terminal 30, it is possible to easily and accurately perform the customer coming process.

In addition, when the payment amount storing process S210 is performed before the customer coming process S220 and the payment amount P is stored in the payment amount storing unit 14 of the passenger terminal 10, this payment amount P is also transmitted to the disposed-at-facility terminal 30. Then, this payment amount P is stored in the payment amount storing unit 31b of the disposed-at-facility terminal 30. Although more details are described later, this payment amount P is used for calculating the second electric power E₂ or the operation fee C.

Additionally, in a case where the boarding certification contains “use time of electric vehicle”, the disposed-at-facility terminal 30 might decide whether the customer coming process performed by the passenger 1 is valid or not, based on this “use time of electric vehicle”. For example, in a case where the time of customer coming process and the use time of electric vehicle are largely deviated from each other (for example, the deviation is equal to or more than 1 day), the disposed-at-facility terminal 30 might determine that the passenger did not use the electric vehicle 200 at the time of coming to the store and might stop the following processes.

### 3) Second Electric Power Calculating Process S230

The disposed-at-facility terminal 30 in the present embodiment performs the second electric power calculating process S230 in which the second electric power E₂ is calculated when the customer coming process is accepted (see FIG. 5). Particularly, in the present embodiment, the boarding certification having been stored in the boarding certification storing unit 31a contains the first electric power E₁. The second electric power calculating unit 32 of the disposed-at-facility terminal 30 extracts the first electric power E₁ from this boarding certification and stores it in the first electric power storing unit 32a. Then, the calculation processing unit 32b of the second electric power calculating unit 32 performs a discounting process on the first electric power E₁ having been stored in the first electric power storing unit 32a so as to calculate the second electric power E₂. Here, a discount rate corresponding to the customer coming process is previously set in the calculation processing unit 32b. The discount rate as described above can be set arbitrary by a manager of the commercial facility 3, or the like. Then, the calculation processing unit 32b treats an electric power amount, in which the first electric power E₁ is decreased on the basis of the discount rate, as the electric power amount (second electric power E₂), while the electric power amount is to be supplied by the passenger 1 as the countervalue for use of the electric vehicle 200. Then, this second electric power E₂ is transmitted to the management terminal 40 and stored in the second electric power storing unit 42. As described above, on the operation management system in accordance with the present embodiment, the electric power amount to be supplied by the passenger 1 as the countervalue for use of the electric vehicle 200 is subtracted by the customer coming process for the commercial facility 3. By doing this, it is possible to provide a merit of substantially discounting the fare to the passenger 1. On the other hand, this subtracting process (second electric power calculating process S230) is not started until the customer coming process S220 is performed on the disposed-at-facility terminal 30 in the commercial facility 3. Thus, it is possible to provide a merit of increasing the number of coming customers, to the commercial facility 3.

Additionally, the disposed-at-facility terminal 30 in the present embodiment is configured to perform subtraction on the second electric power E₂ based on the payment amount P of the passenger 1 for the commercial facility 3. Particularly, the calculation processing unit 32b in the present embodiment is configured to refer to the payment amount P having been stored in the payment amount storing unit 31b when calculating the second electric power E₂ from the first electric power E₁. Then, the calculation processing unit 32b converts a part (for example, about several percent) of the payment amount P of the passenger 1 into the electric power amount, and then performs the subtraction on the calculated electric power amount, so as to calculate the second electric power E₂. In other words, regarding the present embodiment, the second electric power E₂ is reduced more, as the payment amount P of the passenger 1 for the commercial facility 3 becomes larger. By doing this, it is possible to provide a merit of reducing the second electric power E₂ to the passenger 1 and possible to further provide a merit of accelerating consumption activity of the passenger 1 to the commercial facility 3.

### 4) Passenger Notifying Process S240

Next, the disposed-at-facility terminal 30 in the present embodiment notifies the calculated second electric power E₂ to the passenger 1. In particular, the disposed-at-facility terminal 30 transmits information of the second electric power E₂ to the passenger terminal 10 via the communication unit 33. Then, the passenger terminal 10 stores the received information of the second electric power E₂ in the second electric power storing unit 15, and additionally notifies the passenger 1 to supply the second electric power E₂ to the commercial facility 3.

### Supply of Second Electric Power S300

In FIG. 3, “supply of second electric power S300” is a processing step in which the passenger 1 having received the notification about the second electric power E₂ supplies the second electric power E₂ to the commercial facility 3. FIG. 6 is a flowchart that shows a processing procedure of “supply of second electric power S300” in FIG. 3. As shown in FIG. 6, at the supply of second electric power S300, an electric power supplying process S310, an electric power sell contacting process S320, and an electric power reception notifying process S330 are performed.

### 1) Electric Power Supplying Process S310

At the present step, the passenger 1 instructs the private power generating equipment 110 to supply an electric power corresponding to the second electric power E₂ to the commercial facility 3. In particular, the passenger 1 sets the electric power supply processing unit 16 of the passenger terminal 10 to supply the electric power, corresponding to the second electric power E₂, to the commercial facility 3. Then, the electric power supply processing unit 16 transmits the instruction of the passenger 1 to the private power generating equipment 110 via the communication unit 18. Then, the private power generating equipment 110 having received this instruction of the passenger 1 controls charging and discharging to supply the electric power, corresponding to the second electric power E₂, to the commercial facility 3 via the external system 400.

### 2) Electric Power Sell Contacting Process S320

Next, the electric power supply processing unit 16 of the passenger terminal 10 transmits a matter to the management terminal 40 via the communication unit 18, while the matter indicates that the electric power has been supplied from the private power generating equipment 110 to the commercial facility 3. Then, the management terminal 40 compares the second electric power E₂ having been stored in the second electric power storing unit 42 and the electric power having been supplied from the passenger, so as to determine whether the second electric power E₂ is being supplied from the passenger 1 or not.

### (C) Electric Power Reception Notifying Process S330

At the present step, the management terminal 40 transmits a matter to the passenger terminal 10, while the matter represents that the electric power has been received from the private power generating equipment 110. At that time, when the supply electric power from the private power generating equipment 110 has corresponded to the second electric power E₂, the management terminal 40 notifies a matter to the passenger terminal 10, while the matter represents that the second electric power E₂ has been supplied properly. On the other hand, when the supply electric power has been smaller than the second electric power E₂, the management terminal 40 notifies a difference (shortage) between the second electric power E₂ and the supply electric power to the passenger 1 so as to request supplying electric power corresponding to this shortage.

Here, the second electric power E₂ supplied in the present step is used for operation of the commercial facility 3. In general, the commercial facility 3, such as a shopping center, tends to consume an extremely large amount of electric power. Thus, on the commercial facility 3, the possibility is lower that the supply electric power (second electric power E₂) from the passenger 1 becomes surplus electric power. In other words, regarding the commercial facility 3, a merit of having the electric power supplied from the passenger 1 becomes larger than the operating company 2.

### Transfer of Operation Fee S400

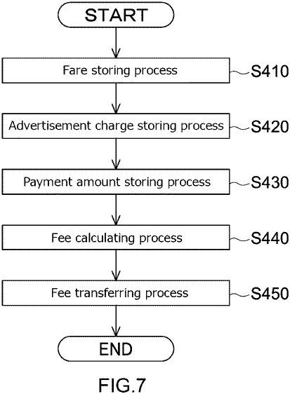

Next, in FIG. 3, “transfer of operation fee S400” is a processing step in which the operation fee C containing the fare F is transferred from the commercial facility 3 to the operating company 2. FIG. 7 is a flowchart that shows a processing procedure of “transfer of operation fee S400” in FIG. 3. As shown in FIG. 7, at this transfer of operation fee S400, a fare storing process S410, an advertisement charge storing process S420, a payment amount storing process S430, a fee calculating process S440, and a fee transferring process S450 are performed.

### 1) Fare Storing Process S410

In the present step, the management terminal 40 obtains the fare F, to be paid by the passenger 1, from the disposed-at-facility terminal 30 and stores it. As described above, regarding the present embodiment, the fare F is contained in the boarding certification. Thus, the management terminal 40 extracts the fare F from the boarding certification having been stored in the boarding certification storing unit 31a and makes the fare storing unit 44a of the price storing unit 44 store it. Incidentally, when the fare F is not contained in the boarding certification, the management terminal 40 can calculate the fare F based on the first electric power E₁.

### 2) Advertisement Charge Storing Process S420

Additionally, the management terminal 40 in the present embodiment obtains the countervalue (advertisement charge A), which is for the advertisement having been displayed in the electric vehicle 200, from the disposed-at-facility terminal 30 and stores it. As described above, in the present embodiment, the boarding certification contains “content of the advertisement having been displayed at on-boarding time”. The management terminal 40 calculates an advertisement charge A based on the content of the advertisement as described above, and stores it in the advertisement charge storing unit 44b. Although more details are described later, this advertisement charge A is added to the operation fee C transferred by the commercial facility 3 to the operating company 2. By doing this, it is possible to provide a merit of increasing pecuniary profits to the operating company 2 which has contributed in increasing the number of customers coming to the commercial facility 3.

### 3) Payment Amount Storing Process S430

Next, the management terminal 40 obtains the payment amount P of the passenger, which is for the commercial facility 3, from the disposed-at-facility terminal 30 and stores it. In particular, the management terminal 40 obtains the payment amount P from the payment amount storing unit 31b of the disposed-at-facility terminal 30, and stores it in the payment amount storing unit 44c. Although more details are described later, the added price P1 having been calculated on the basis of this payment amount P is also added to the operation fee C. By doing this, it is possible to provide a merit of increasing pecuniary profits to the operating company 2 which has contributed in having the passenger 1 paying large prices come to the store.

### 4) Fee Calculating Process S440

Next, the fee calculating unit 46 of the management terminal 40 calculates the operation fee C based on the various prices having been stored in the price storing unit 44. The fee calculating unit 46 in the present embodiment, at first, calculates the added price P1 based on the payment amount P of the passenger 1. This added price P1 can be, for example, set within a range of approximately several percent of the payment amount P. Then, the fee calculating unit 46 calculates the operation fee C by adding the fare F, the advertisement charge A, the added price P1, and a customer coming reward R. Incidentally, “customer coming reward R” herein is a fixed amount price that has been previously set, and is set to be automatically added when the passenger 1 has performed the customer coming process. By setting the customer coming reward R as described above, it is possible to more surely secure the pecuniary profit of the operating company 2. Then, in the present embodiment, the various prices described above are added to the fare F so as to calculate the operation fee C. By doing this, it is possible to increase the pecuniary profit of the operating company 2, and thus it is possible to increase the motivation of the operating company 2 for introducing the present system.

### 5) Fee Transferring Process S450

Next, at the present step, the operation fee C calculated by the fee calculating unit 46 is transferred to the operating company 2. In particular, the operation fee C is transmitted to the fee transferring unit 48 from the fee calculating unit 46. The fee transferring unit 48 transfers the operation fee C to a bank account of the operating company 2 through the communication unit 49 and the outside network. As described above, in the operation management system according to the present embodiment, the operation fee C (various prices containing the fare F) is transferred to the operating company 2 from the commercial facility 3 to which the passenger 1 has come. In other words, according to the present system, it is possible to provide the operating company 2 with a merit of being able to obtain the pecuniary profit easily in comparison with the conventional system.

### 3. Summary

As described above, the operation management system in accordance with the present embodiment includes the on-vehicle terminal 20 that is mounted on the electric vehicle 200 possessed by the operating company 2 and that is configured to calculate the first electric power E₁ in which the fare F to be paid by the passenger 1 is converted to the electric power, includes the disposed-at-facility terminal 30 that is disposed on the commercial facility 3 and that is configured to calculate the second electric power E₂ in which the discounting process is performed on the first electric power E₁ by the customer coming process performed by the passenger 1, includes the electric power supply processing unit 16 that is configured to perform processing in which the passenger 1 supplies the second electric power E₂ to the commercial facility 3, and includes the fee transferring unit 48 that is configured to transfer the operation fee C containing the fare F from the commercial facility 3 to the operating company 2.

In this operation management system, by performing the customer coming process in which the passenger 1 uses the electric vehicle 200 to input the matter of coming to the commercial facility 3 into the disposed-at-facility terminal 30, it is possible to use the electric vehicle 200 with the second electric power E₂ on which the discounting process has been performed. In other words, in the present system, it is possible to provide the passenger 1 with a new merit of substantially discounting the fare F, in addition to the merit of being able to use the transportation service with the surplus electric power. Next, in the operation management system according to the present embodiment, an operation fee C is transferred to the operating company 2 from the commercial facility 3 at which the passenger 1 has performed the customer coming process. Thus, according to the present system, it is possible to provide the operating company 2 with the merit of obtaining the pecuniary profit more easily in comparison with the conventional system. Then, in the operation management system according to the present embodiment, the second electric power E₂ being the countervalue at the time when the passenger 1 used the electric vehicle 200 is supplied to the commercial facility 3. As described above, the commercial facility 3 takes a larger merit, for which the surplus electric power is supplied, than the operating company 2. Furthermore, in the present system, it is required for the passenger 1 to perform the customer coming process with the disposed-at-facility terminal 30 inside the commercial facility 3. Thus, in accordance with the present system, it is possible to provide the most important merit for the commercial facility 3 that is increase in the number of coming customers. As described above, by the operation management system in accordance with the present embodiment, it is possible to generate a predetermined level of advantage for each system user.

### Another Embodiment

Above, one embodiment of the herein disclosed technique has been explained. Incidentally, the above described embodiment is an example to which the herein disclosed technique is applied, and is not to restrict the herein disclosed technique.

For example, as shown in FIG. 1 and FIG. 2, the above described embodiment includes the management terminal 40 having the built-in fee transferring unit 48. However, it is sufficient for the fee transferring unit of the herein disclosed technique to be built in a terminal capable of transferring the operation fee from the commercial facility to the operating company, and the fee transferring unit is not restricted to a form built in the management terminal. For example, the fee transferring unit might be built in the disposed-at-facility terminal, or might be built in an outside computer capable of communicating with the disposed-at-facility terminal. Even in these forms, it is possible to transfer the operation fee from the commercial facility to the operating company.

Additionally, in the above described embodiment, the passenger 1 possesses the passenger terminal 10. However, in the herein disclosed technique, the passenger terminal 10 is not an essential configuration. In other words, even when the passenger 1 does not possess the passenger terminal 10, it is possible to implement the operation management system disclosed herein. For example, in the above described embodiment, the boarding certification at the time of boarding the electric vehicle 200 is stored in the boarding certification storing unit 12 of the passenger terminal 10. However, the boarding certification can be issued in a magnetic-sheet form that records the boarding information containing the fare F. At that time, it is possible to perform the customer coming process by making the disposed-at-facility terminal read the magnetic sheet. Additionally, in the case where the magnetic sheet is used, it is preferable that the second electric power having been calculated after the customer coming process is printed on the magnetic sheet. By doing this, it is possible to notify the passenger about the second electric power to be supplied by the passenger to the commercial facility. Additionally, in the above described embodiment, the electric power supply processing unit 16 is built in the passenger terminal 10. However, the electric power supply processing unit might be built in a PC disposed in a house of the passenger, or the like. Even when the electric power supply processing unit having the configuration as described above is used, it is possible to supply the second electric power from the private power generating equipment to the commercial facility.

In the above described embodiment, by adding various prices (added price P1 based on the payment amount P, advertisement charge A, customer coming reward R, or the like) to the fare F, the operation fee C is calculated. However, it is sufficient that the operation fee C contains the fare F to be paid by the passenger, and thus the other prices might not be added to the operation fee. Even in a case where only the fare F is transferred as the operation fee C to the operating company, it is possible to provide the operating company with the merit of easily obtaining the pecuniary profit. Incidentally, it is preferable that whether a price other than the fare F is added or not is suitably set on the basis of a contract with the commercial facility and the operating company.

Additionally, in the herein disclosed operation management system, the passenger information is stored in the on-vehicle terminal of the electric vehicle and in the disposed-at-facility terminal of the commercial facility. By using this configuration, it is also possible to provide a service of notifying the passenger’s position to the family. For example, when the passenger is an old person or a child, it is possible that a guardian can confirm the position of the passenger by using the PC in the house to communicate with the on-vehicle terminal or the disposed-at-facility terminal. Additionally, as described above, in the herein disclosed operation management system, the operation fee is transferred from the commercial facility to the operating company. Incidentally, “commercial facility” herein is a term semantically covering a store existing in this commercial facility. In other words, when the present system is introduced to a commercial facility like a shopping center including many stores, it might be set to make the store, having been actually used by the passenger, pay the operation fee.

In addition, “transfer of operation fee S400” of the above described embodiment is explained about a case where the operation fee caused by one passenger having come to the store is individually transferred. However, in “transfer of operation fee”, operation fees caused by plural passengers might be transferred together. For example, the commercial facility can sum up the operation fees for a predetermined period (typically, for one month) so as to transfer the sum to the operating company. In addition, similarly, “supply of second electric power” is not restricted to the above described embodiment, neither. In other words, the passenger can sum the second electric power for a predetermined period (typically, for one month) so as to supply the sum to the commercial facility.

Although the present disclosure is explained above in details, the above described explanation is merely an illustration. In other words, the herein disclosed technique contains ones in which the above described specific examples are deformed or changed.

What is claim is:

1. An operation management system for an electric vehicle, comprising:
an on-vehicle terminal that is mounted on the electric vehicle possessed by an operating company and that is configured to calculate a first electric power in which a fare to be paid by a passenger is converted into an electric power;
a disposed-at-facility terminal that is disposed at a commercial facility and that is configured to calculate a second electric power in which a discounting process is performed on the first electric power in response to a customer coming process performed by the passenger;
an electric power supply processing unit that is configured to perform a process in which the passenger supplies the second electric power to the commercial facility; and
a fee transferring unit that is configured to transfer an operation fee containing the fare from the commercial facility to the operating company.

2. The operation management system according to claim 1, wherein
the on-vehicle terminal comprises a boarding certification issuing unit that is configured to issue a boarding certification which is boarding information containing the first electric power, and
at the customer coming process, the passenger makes the disposed-at-facility terminal read the boarding certification.

3. The operation management system according to claim 1, wherein
an image display apparatus and an advertisement displaying unit configured to display an advertisement of the commercial facility on the image display apparatus are mounted on the electric vehicle, and
the fee transferring unit is configured to add a countervalue of the advertisement to the operation fee and transfer to the operating company.

4. The operation management system according to claim 1, wherein
an advertisement transmitting unit configured to transmit an advertisement of the commercial facility to a portable terminal possessed by the passenger is mounted on the electric vehicle, and
the fee transferring unit is configured to add a countervalue of the advertisement to the operation fee so as to transfer to the operating company.

5. The operation management system according to claim 1, wherein
the fee transferring unit is configured to add a customer coming reward, corresponding to the passenger coming to a store, to the operation fee so as to transfer to the operating company.

6. The operation management system according to any one of claim 1, wherein
the disposed-at-facility terminal is configured to subtract the second electric power based on a payment amount of the passenger at the commercial facility.

7. The operation management system according to claim 6, wherein
the fee transferring unit is configured to add a part of the payment amount of the passenger at the commercial facility to the operation fee so as to transfer to the operating company.

8. An operation management program configured to make a computer perform:
a step for calculating a first electric power in which a fare, to be paid by a passenger with respect to use of an electric vehicle possessed by an operating company, is converted into an electric power;
a step for calculating a second electric power in which a discounting process is performed on the first electric power when a customer coming process for recording that the passenger has come to a commercial facility is performed;
a step for supplying the second electric power by the passenger to the commercial facility; and
a step for transferring an operation fee containing the fare to the operating company from the commercial facility.
